(19) United States
(12) Patent Application Publication
(10) Pub. No.: US 2020/0042354 A1
(43) Pub. Date: Feb. 6, 2020

(54) ANALYSIS NODE, METHOD FOR MANAGING RESOURCES, AND PROGRAM RECORDING MEDIUM

(71) Applicant: NEC Corporation, Tokyo (JP)

(72) Inventors: Takeshi ARIKUMA, Tokyo (JP); Takatoshi KITANO, Tokyo (JP)

(73) Assignee: NEC Corporation, Tokyo (JP)

(21) Appl. No.: 16/601,899

(22) Filed: Oct. 15, 2019

Related U.S. Application Data
(63) Continuation of application No. 16/349,320.

(30) Foreign Application Priority Data
Nov. 22, 2016 (JP) 2016-226465

(51) Int. Cl. G06F 9/50; G06F 9/38

(52) U.S. Cl. CPC G06F 9/505; G06F 9/5016; G06F 9/3836; G06F 9/5038; G06F 9/5044

(57) ABSTRACT

[Problem] To provide an analysis node capable of appropriately managing computational resources in relation to load fluctuation, and continuously performing analysis processing with high throughput. [Solution] An analysis node includes an analysis execution means 1, a content variation observation means 2, and a resource allocation means 3. The analysis execution means 1 performs analysis processing that includes a plurality of steps including at least a pre-stage step and a post-stage step, by computational resources allocated to each of the steps. The content variation observation means 2 observes, as content variation observation information, content change of processing-target data at the pre-stage step. The resource allocation means 3 predicts fluctuation in a processing load at the post-stage step, based on the content variation observation information, and changes the computational resources allocated to the post-stage step.

### REFERENCE TO RELATED APPLICATION

This present application is a Continuation Application of Ser. No. 16/349,320 filed on May 13, 2019, which is a National Stage Entry of International Application PCT/JP2017/041476 filed on Nov. 17, 2017, which claims the benefit of priority from Japanese Patent Application 2016-226465 filed on Nov. 22, 2016, the disclosures of all of which are incorporated in their entirety by reference herein.

### TECHNICAL FIELD

The present invention relates to analysis processing, and particularly relates to a technique in performing analysis processing including a plurality of steps.

### BACKGROUND ART

In a video analysis system or the like, it may be required to analyze continuously occurring data in short time. For a use in which a real-time property is required, it is required to perform analysis processing without decreasing throughput even when analysis-target data increase. For this reason, in a video analysis system or the like, computational resources of a server that performs analysis, i.e., resources need to be appropriately allocated to analysis processing. As one example of such a video analysis resource management system, a technique such as that of NPL 1 is disclosed.

FIG. 14 illustrates an outline of a configuration of a video analysis resource management system described in NPL 1. A video resource management system of NPL 1 includes a deployment management server (Nimbus), an analysis worker node group (worker node), and scheduler plugins. The video resource management system of NPL 1 further includes an analysis execution worker process (worker process), a performance information monitoring thread (monitoring thread), and a performance information storage unit (performance log).

In the video analysis resource management system in FIG. 14, the performance information monitoring thread collects performance information such as use time of a central processing unit (CPU) of the analysis execution worker process, and accumulates the collected performance information in the performance information storage unit. In the video analysis resource management system in FIG. 14, the scheduler plugins periodically calculate an optimum number of processes and an optimum number of threads, based on the collected performance information, and generates a new deployment plan. In the video analysis resource management system in FIG. 14, the deployment management server stops the analysis execution worker processes of all of the analysis workers, and activates new analysis execution worker processes in all of the analysis workers, based on the generated new deployment plan.

### CITATION LIST

### Non Patent Literature

[NPL 1] Leonardo Aniello et. al, “Adaptive Online Scheduling in Storm”, DEBS '13 Proceeding of the 7th ACM International conference, Association for Computing Machinery, p. 207-p. 209

### SUMMARY OF INVENTION

### Technical Problem

However, the technique of NPL 1 is not sufficient in the following point. In the technique of NPL 1, the analysis execution worker processes are stopped and activated in order to deal with the generated new deployment plan, and temporal stop of the analysis processing occurs periodically during the re-deployment. Further, in the periodic re-deployment processing, excess or lack of resources may occur when a load fluctuates frequently, and throughput may decrease due to occurrence of idle resources, and delay may occur due to occurrence of a resource queue. For this reason, the technique of NPL 1 cannot achieve both a real-time property and high throughput in a system in which a load fluctuates frequently.

In order to solve the above-described problem, an object of the present invention is to provide an analysis node, a method for managing resources, and a resource management program, in which computational resources can be appropriately managed in relation to load fluctuation, and an analysis processing can be continuously performed with high throughput.

### Solution to Problem

In order to solve the above-described problem, an analysis node according to the present invention includes an analysis execution means, a content variation observation means, and a resource allocation means. The analysis execution means performs analysis processing that includes a plurality of steps including at least a pre-stage step and a post-stage step, by computational resources respectively allocated to the steps. The content variation observation means observes, as content variation observation information, content change of processing-target data at the pre-stage step. The resource allocation means predicts fluctuation in a processing load at the post-stage step, based on the content variation observation information, and changes the computational resources allocated to the post-stage step.

When performing analysis processing that includes a plurality of steps including at least a pre-stage step and a post-stage step, by computational resources respectively allocated to the steps, a method for managing resources according to the present invention observes, as content variation observation information, content change of processing-target data at the pre-stage step. The method for managing resources according to the present invention predicts fluctuation in a processing load at the post-stage step, based on the content variation observation information, and changes the computational resources allocated to the post-stage step.

A resource management program according to the present invention causes a computer to execute content variation observation processing and resource allocation processing, when performing analysis processing that includes a plurality of steps including at least a pre-stage step and a post-stage step, by computational resources respectively allocated to the steps. Concerning the analysis processing that includes a plurality of the steps, the content variation observation processing observes content variation of target data from the analysis processing at the pre-stage step. The resource allocation processing predicts fluctuation in a processing load at the post-stage step, based on the content variation observation information, and changes the computational resources allocated to the post-stage step.

### Advantageous Effects of Invention

According to the present invention, it is possible to appropriately manage computational resources in relation to load fluctuation, and continuously perform analysis processing with high throughput.

### BRIEF DESCRIPTION OF DRAWINGS

FIG. 1 is a diagram illustrating an outline of a configuration of a first example embodiment of the present invention.

FIG. 2 is a diagram illustrating an outline of a configuration of a second example embodiment of the present invention.

FIG. 3 is a block diagram illustrating a configuration of an analysis node of the second example embodiment of the present invention.

FIG. 4 is a diagram illustrating an example of load observation data of the second example embodiment of the present invention.

FIG. 5 is a diagram illustrating an example of content observation data of the second example embodiment of the present invention.

FIG. 6 is a diagram illustrating an operation flow in the second example embodiment of the present invention.

FIG. 7 is a diagram illustrating an operation flow in the second example embodiment of the present invention.

FIG. 8 is a diagram schematically illustrating an example of input data in the second example embodiment of the present invention.

FIG. 9 is a diagram illustrating an example of data in processing of predicting load fluctuation in the second example embodiment of the present invention.

FIG. 10 is a diagram illustrating an example of a processing load and resource allocation in the second example embodiment of the present invention.

FIG. 11 is a diagram illustrating an outline of a configuration of a third example embodiment of the present invention.

FIG. 12 is a block diagram illustrating a configuration of an analysis node according to the third example embodiment of the present invention.

FIG. 13 is a diagram illustrating an operation flow in the third example embodiment of the present invention.

FIG. 14 is a diagram illustrating an example of an analysis system having a configuration compared with the present invention.

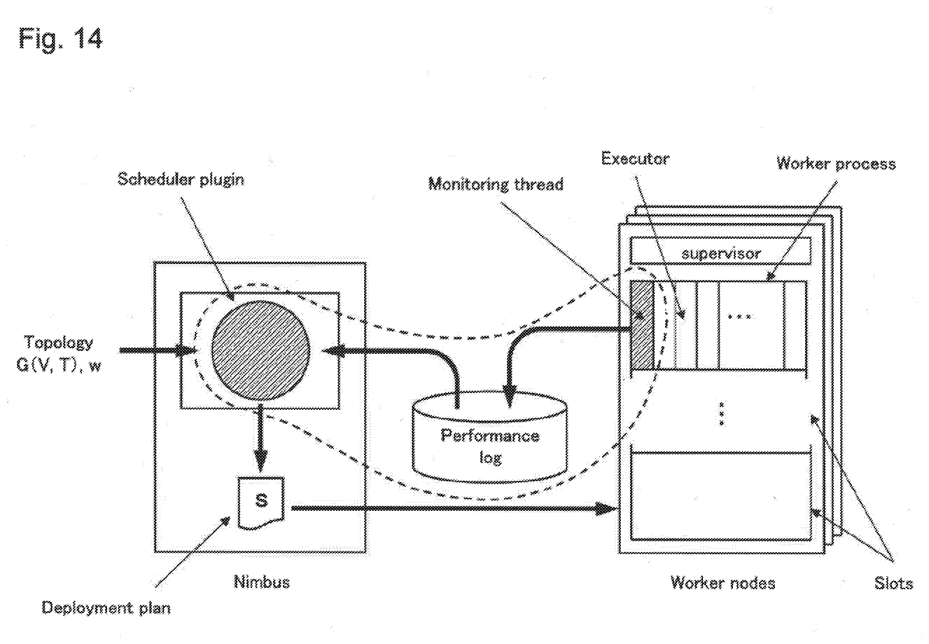

### EXAMPLE EMBODIMENT

### First Example Embodiment

### Configuration of First Example Embodiment

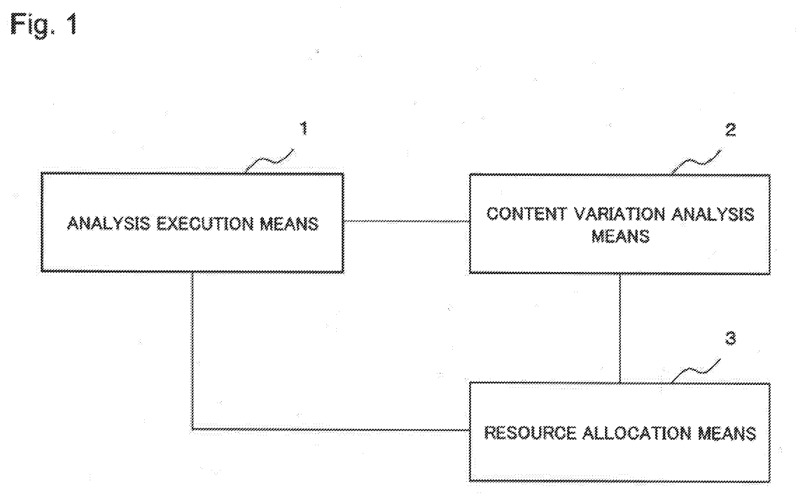

A first example embodiment of the present invention is described in detail with reference to the drawing. FIG. 1 illustrates an outline of a configuration of an analysis node in the present example embodiment. The analysis node in the present example embodiment includes an analysis execution means 1, a content variation observation means 2, and a resource allocation means 3. The analysis execution means 1 executes analysis processing including a plurality of steps that include at least a pre-stage step and a post-stage step, by computational resources respectively allocated to the steps. The content variation observation means 2 observes, as content variation observation information, content change in processing-target data at the pre-stage step. The resource allocation means 3 predicts fluctuation in a processing load at the post-stage step, based on the content variation observation information, and changes computational resources allocated to the post-stage step.

### Advantageous Effect of First Example Embodiment

In the analysis node in the present example embodiment, the content variation observation means 2 observes, as content variation observation information, content change of the pre-stage step. Further, in the analysis node in the present example embodiment, the resource allocation means 3 predicts fluctuation in a load at the post-stage step, based on the content variation observation information, and based on a prediction result, changes computational resources allocated to the post-stage step. Thus, based on the change at the pre-stage step, a load at the post-stage step is predicted, and allocation of computational resources to the post-stage step is changed, thereby enabling analysis processing to be performed without lowering throughput when a load fluctuates. In addition, at a time of performing analysis processing, the analysis node in the present example embodiment can dynamically change allocation of computational resources to the post-stage step, based on the change at the pre-stage step, and thus, does not need to stop analysis processing when changing allocation of computational resources. As a result, using the analysis node in the present example embodiment enables computational resources to be appropriately managed in relation to a load variation, and enables analysis processing to be continuously performed with high throughput.

### Second Example Embodiment

### Configuration of Second Example Embodiment

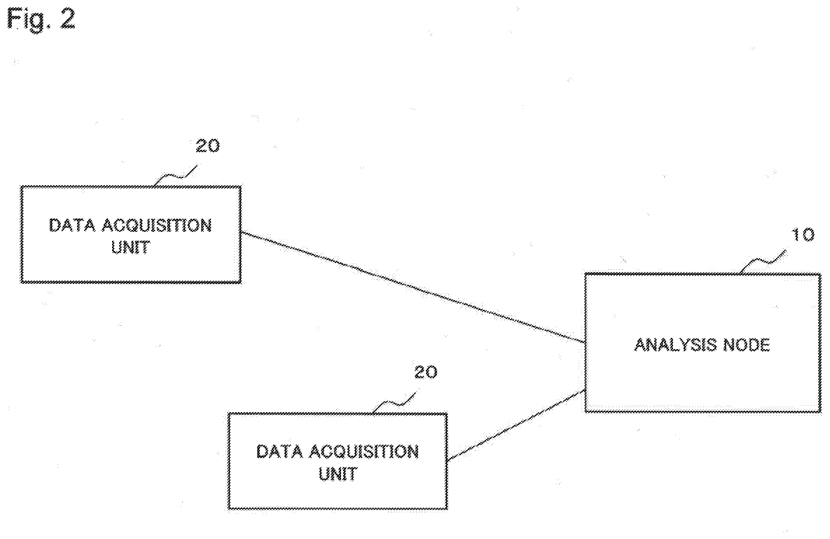

A second example embodiment of the present invention is described in detail with reference to the drawings. FIG. 2 illustrates a configuration of an analysis system in the present example embodiment. The analysis system in the present example embodiment includes an analysis node 10 and a data acquisition unit 20.

In the analysis system in the present example embodiment, data input from the data acquisition unit 20 to the analysis node 10 are analyzed by analysis processing of two stages of a pre-stage step and a post-stage step at the analysis node 10. The analysis system in the present example embodiment is used, for example, as an image analysis system that detects a face of a person from input video data, and further extracts a characteristic of the detected face.

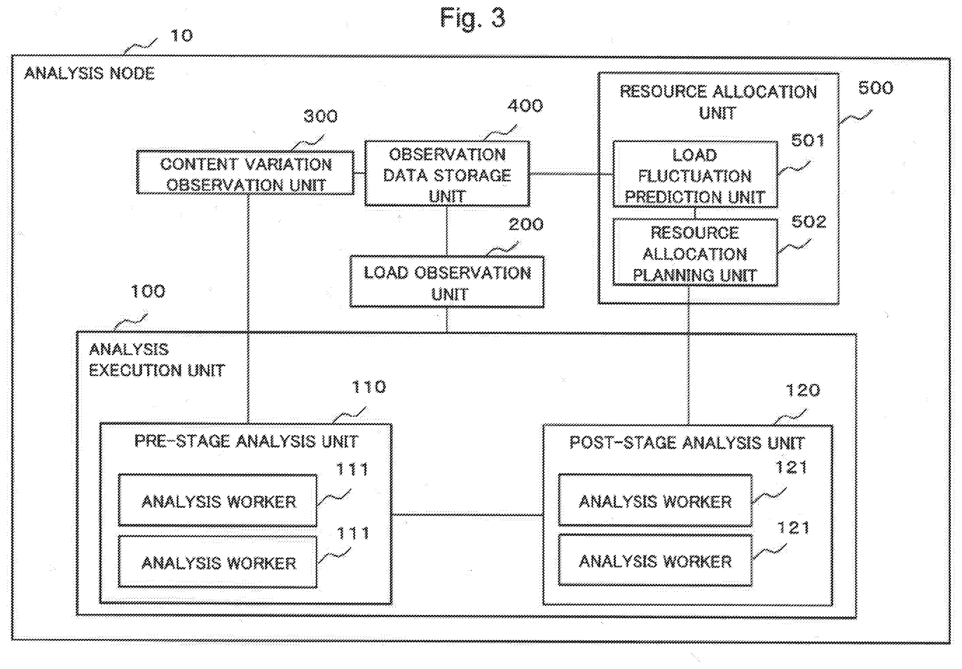

A configuration of the analysis node 10 is described. FIG. 3 is a block diagram illustrating a configuration of the analysis node 10 in the present example embodiment. The analysis node 10 includes an analysis execution unit 100, a load observation unit 200, a content variation observation unit 300, an observation data storage unit 400, and a resource allocation unit 500.

The analysis execution unit 100 performs analysis processing on data input from the data acquisition unit 20. The analysis execution unit 100 further includes a pre-stage analysis unit 110 and a post-stage analysis unit 120. The pre-stage analysis unit 110 further includes a plurality of analysis workers 111. The post-stage analysis unit 120 further includes a plurality of analysis workers 121. Although FIG. 3 illustrates an example in which two analysis workers 111 and two analysis workers 121 are provided, the number of the analysis workers 111 and the number of the analysis workers 121 may each be each one, or may each be equal to or larger than three.

In the analysis execution unit 100, the analysis workers 111 of the pre-stage analysis unit 110 perform, on input data, primary processing as the pre-stage step. Further, in the analysis execution unit 100, the analysis workers 121 of the post-stage analysis unit 120 perform, on the processing result of the primary processing, secondary processing as the post-stage step, and outputs the result as a final result. The analysis workers 111 of the pre-stage analysis unit 110 output, to the post-stage analysis unit 120, only data that satisfy a predetermined quality standard, among the data of the processing result of the primary processing. The predetermined quality standard is set as a standard for determining whether or not data enable analysis processing at the post-stage step to be performed normally.

When the analysis system in the present example embodiment is used as a video analysis system for example, at the pre-stage step, the analysis workers 111 detect a face of a person appearing in video, from video data from the data acquisition unit 20. The analysis workers 111 of the pre-stage analysis unit 110 output, to the post-stage analysis unit 120, as an analysis result, data of a face having a size equal to or larger than a standard size, among detected faces.

A standard for determining a size of a face to be output as data of an analysis result by the pre-stage analysis unit 110 is preset as a size sufficient for extracting a characteristic quantity of a face at the post-stage step in the post-stage analysis unit 120. In other words, when the analysis system in the present example embodiment is used as a video analysis system, the predetermined quality standard is set as a size of a face.

In the post-stage analysis unit 120, the analysis workers 121 perform analysis processing of the post-stage step on data input from the pre-stage analysis unit 110, and output the processing result as a final result. When the analysis system in the present example embodiment is used as a video analysis system, at the post-stage step, the analysis workers 121 of the post-stage analysis unit 120 extract a characteristic quantity of a face from a face detected by the analysis workers 111. In other words, the pre-stage analysis unit 110 performs, as an analysis task, detection of a face from input video data. Further, the post-stage analysis unit 12 performs, as an analysis task, extraction of data of a characteristic quantity of a face from the detected face.

The analysis execution unit 100 is constituted of a central processing unit (CPU) including a plurality of cores, a semiconductor storage device, a hard disk drive for recording programs executed by the CPU cores, and the like. As the programs executed by the CPU cores, programs for an operating system (OS) and analysis processing are recorded. The programs for the OS and the analysis processing may be recorded in a nonvolatile semiconductor storage device. The pre-stage analysis unit 110 and the post-stage analysis unit 120 perform analysis processing on data at the CPU cores respectively allocated thereto. The analysis execution unit 100 in the present example embodiment corresponds to the analysis execution means 1 of the first example embodiment.

The load observation unit 200 observes loads of computational resources of the analysis execution unit 100, and stores, as load observation data, the observed result in the observation data storage unit 400. For example, the load observation unit 200 observes, as loads of the computational resources, consumption quantities of the CPU cores and a memory that are the computational resources of the analysis execution unit 100. A consumption quantity of the CPU core is observed as use time of the CPU core, for example. A consumption quantity of the memory is observed as a value of storage capacity that is being used for the analysis processing. The load observation unit 200 may observe, as the load observation data, throughput of the analysis processing.

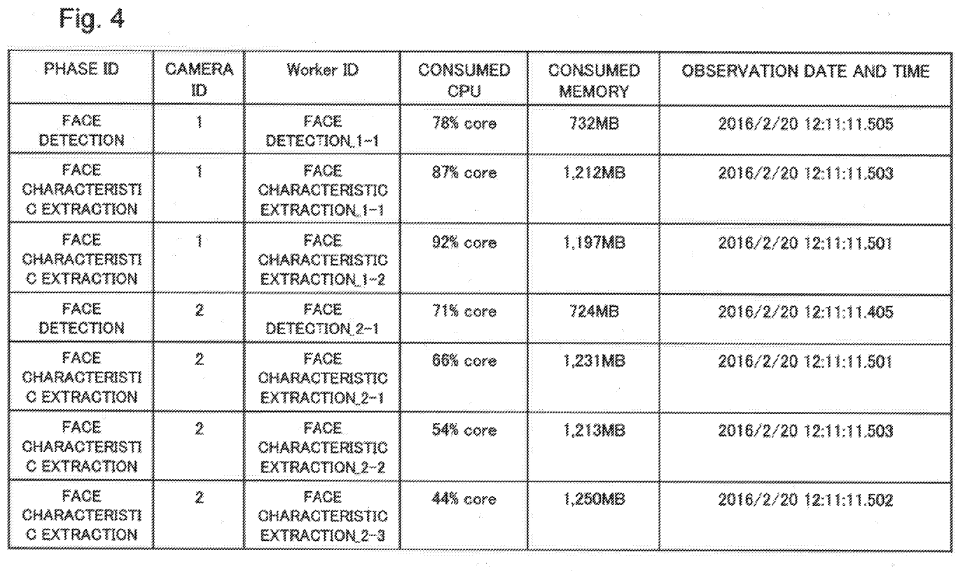

FIG. 4 illustrates an example of the load observation data observed by the load observation unit 200 in the video analysis system. The load observation data in FIG. 4 is composed of phase ID, camera ID, worker ID, a consumed CPU, a consumed memory, and information of observation date and time. The phase ID indicates which of the pre-stage step and the post-stage step is being performed. In FIG. 4, the processing at the pre-stage step is represented as “face detection”, and the processing at the post-stage step is represented as “face characteristic extraction”. As the phase ID, a character string, a numerical value, a flag, or the like that indicates an execution content can be used. Alternatively, as the phase ID, a flag indicating the pre-stage or the post-stage may be used. The camera ID indicates an identifier of a camera that is a transmission source of analysis-target video data. In FIG. 4, video data are input from two cameras whose camera IDs are “1” and “2”.

The worker IDs indicates identifiers of the analysis workers 111 and the analysis workers 121. As the identifier of the worker ID, process ID of the OS, a sequence number or character string allocated at a time of activation, or the like may also be used. The consumed CPU and the consumed memory indicate consumed quantities of the CPU core and the memory, respectively. The observation date and time indicates a date and time when the load observation data are observed.

The content variation observation unit 300 observes content change in analysis-target data in the pre-stage analysis unit 110, and stores the observed result, as content observation data, in the observation data storage unit 400. The content variation observation unit 300 acquires the number of pieces of data of an analysis result output by the pre-stage analysis unit 110 to the post-stage analysis unit 120, and the number of pieces of data of an internally held analysis result, and stores, in the observation data storage unit 400, the acquired numbers. In the present example embodiment, data that are internally held without being output to the post-stage analysis unit 120 by the pre-stage analysis unit 110 are referred to as internal information. The content variation observation unit 300 in the present example embodiment corresponds to the content variation observation means 2 of the first example embodiment.

When the analysis system is a video analysis system, the internal information corresponds to a detection result of a face that is among faces detected from an image by the pre-stage analysis unit 110 and that is not sent to processing of the post-stage analysis unit 120 because of being smaller than the standard.

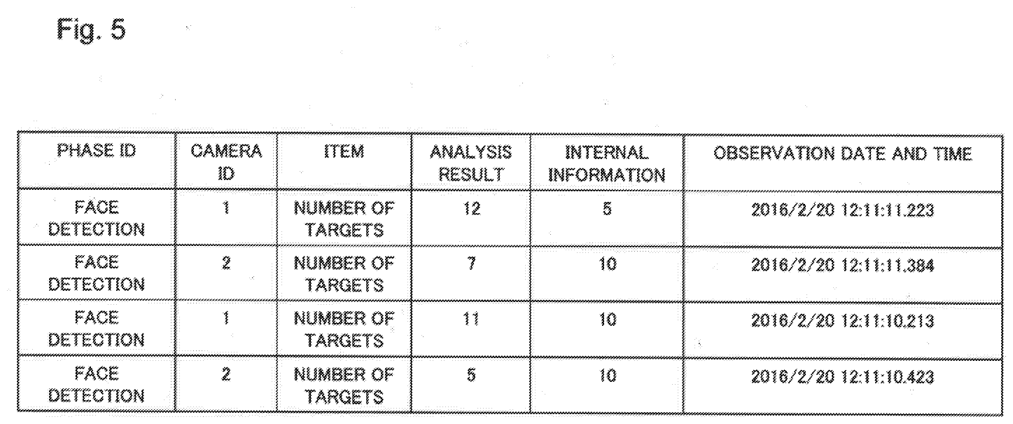

FIG. 5 illustrates an example of content observation data in the video analysis system. The content observation data in FIG. 5 is composed of phase ID, camera ID, an item, an analysis result, internal information, and information of observation date and time. The phase ID indicates processing contents of an observation target. The “face detection” of the phase ID indicates face detection processing at the pre-stage step. As the phase ID, a numerical value, a flag, or the like may be used instead of a character string indicating analysis contents. The camera ID indicates an identifier of a camera that is a transmission source of the video data for analysis. The item indicates an attribute of video data that are being observed. Since the number of faces included in video data is a processing target, the “number of targets” is set as the item in FIG. 5. The analysis result indicates the number of pieces of data included in data output to the post-stage analysis unit 120 by the analysis workers 111 of the pre-stage analysis unit 110. The internal information indicates the number of pieces of data that are not output to the post-stage analysis unit 120 by the analysis workers 111 of the pre-stage analysis unit 110. The analysis result and the content information may be other than numerical data. The analysis result and the content information may be values such as a matrix or a vector, for example. The observation date and time indicates a date and time when the content observation data are observed.

The observation data storage unit 400 stores information of content change of analysis-target data acquired from the pre-stage analysis unit 110 by the content variation observation unit 300. The content change means change in the number of pieces of data of an analysis result and content information, for example. The observation data storage unit 400 stores load observation data of the analysis execution unit 100 observed by the load observation unit 200. The observation data storage unit 400 is constituted of a semiconductor storage device, for example. The observation data storage unit 400 may be constituted of another storage device such as a hard disk drive.

The resource allocation unit 500 has a function of dynamically changing allocation of computational resources such as the CPU cores and the memory to the post-stage analysis unit 120, based on content observation data of observed change in analysis processing that is being performed by the pre-stage analysis unit 110. The resource allocation unit 500 further includes a load fluctuation prediction unit 501 and a resource allocation planning unit 502.

The load fluctuation prediction unit 501 predicts a load occurring in the post-stage analysis unit 120, based on content observation data and load observation data. The load fluctuation prediction unit 501 acquires content observation data and load observation data from the observation data storage unit 400, predicts a load of the post-stage analysis unit 120, and outputs the predicted load as load information to the resource allocation planning unit 502.

Based on the load information, the resource allocation planning unit 502 changes a computational resource quantity allocated to the post-stage analysis unit 120. For example, the resource allocation planning unit 502 increases or decreases the number of OS processes corresponding to the analysis workers 121. Changing the number of the CPU cores, capacity of the memory, or the like allocated to the analysis workers 121 enables optimum allocation of resources to be performed. The resource allocation unit 500 in the present example embodiment corresponds to the resource allocation means 3 of the first example embodiment.

The load observation unit 200, the content variation observation unit 300, and the resource allocation unit 500 are configured by a CPU, a semiconductor storage device, a hard disk drive that records a program for performing each processing, and the like. The load observation unit 200, the content variation observation unit 300, and the resource allocation unit 500 may each be independent units, or may operate in the same unit. The CPU and the storage device constituting the load observation unit 200, the content variation observation unit 300, and the resource allocation unit 500 may be the same unit as one or both of the analysis execution unit 100 and the observation data storage unit 400.

The data acquisition unit 20 acquires data to be analyzed, and sends the acquired data to the analysis node 10. When the analysis system is a video analysis system, the data acquisition unit 20 corresponds to a camera that captures video, for example. Video data captured by the camera are transmitted to the analysis node 10 via a communication line. The analysis system of the present example embodiment includes two data acquisition units 20. The number of the data acquisition units 20 may be other than two.

### Operation of Second Example Embodiment

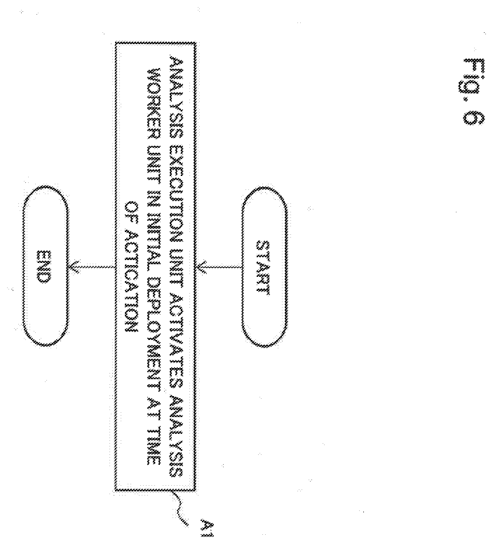

An operation of the analysis system in the present example embodiment is described. First, an operation at a time of activation of the analysis system is described. FIG. 6 illustrates a system activation operation in the analysis system of the preset example embodiment.

When the analysis system is activated by operator's operation or the like, and the analysis node 10 is activated, the analysis execution unit 100 activates the analysis workers 111 and the analysis workers 121 in initial deployment (step A1). The initial deployment is preset based on a specification of the analysis system or the like.

When the analysis workers 111 and the analysis workers 121 are activated in initial deployment, the analysis execution unit 100 analyzes analysis-target data input from the data acquisition unit 20. When the analysis-target data are input to the analysis execution unit 100, the analysis workers 111 of the pre-stage analysis unit 110 perform, as the pre-stage step, analysis on the input data. The pre-stage analysis unit 110 sends, to the post-stage analysis unit 120, the analysis result as a result of the primary processing at the pre-stage step.

When the processing result of the primary processing is input to the post-stage analysis unit 120, the analysis workers 121 of the second-stage analysis unit 120 perform, as the post-stage step, analysis on the processing result of the primary processing. The post-stage analysis unit 120 outputs the analysis result as a result of the secondary processing at the post-stage step, i.e., as a final result.

The analysis execution unit 100 repeatedly performs analysis on input analysis-target data and performs output of the analysis result each time the analysis-target data are input.

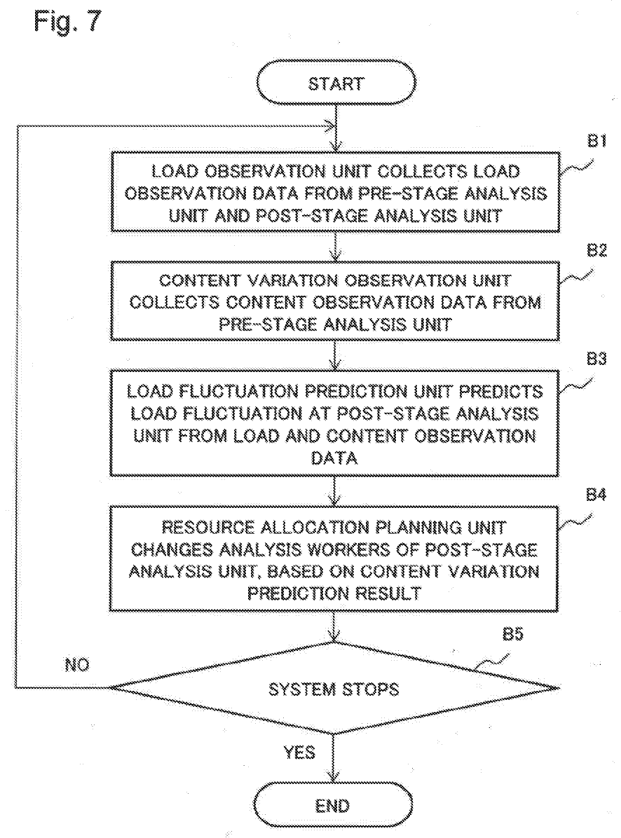

Next, description is made on an operation at a time of changing allocation of computational resources in the analysis system in the present example embodiment. FIG. 7 illustrates an operation flow at a time of dynamically changing allocation of computational resources in the analysis system in the present example embodiment.

When the analysis execution unit 100 is performing analysis on input data and performing output of the analysis result, the load observation unit 200 monitors loads of the pre-stage analysis unit 110 and the post-stage analysis unit 120 of the analysis execution unit 100. The load monitoring unit 200 collects, as load observation data, information of loads of the pre-stage analysis unit 110 and the post-stage analysis unit 120 (step B1). The load observation unit 200 stores the collected load observation data in the observation data storage unit 400.

The content variation observation unit 300 collects, as content observation data, an analysis result and internal information from the pre-stage analysis unit 110 (step B2). The content variation observation unit 300 stores the collected content observation data in the observation data storage unit 400.

When the load observation data and the content observation data are stored, the load fluctuation prediction unit 501 predicts load fluctuation of the post-stage analysis unit 120, based on the load observation data and the content observation data stored in the observation data storage unit 400 (step B3).

For example, the load fluctuation prediction unit 501 predicts load fluctuation of the post-stage analysis unit 120 by prediction with a learning model base that is based on a history of past load fluctuation. Alternatively, the load fluctuation prediction unit 501 may predict load fluctuation of the post-stage analysis unit 120 by prediction with a rule base, based on a preset rule. When predicting load fluctuation, the load fluctuation prediction unit 501 sends the prediction result to the resource allocation planning unit 502.

When receiving the prediction result of the load fluctuation, the resource allocation planning unit 502 changes the number of the analysis workers 121 in the post-stage analysis unit 120 and allocation of computational resources to the analysis workers 121 (step B4). When a configuration of the post-stage analysis unit 120 is reset by the resource allocation planning unit 502, the analysis execution unit 100 performs analysis on input analysis-target data and performs output of the analysis result, based on the reset configuration. When the analysis system is operating (no at step B5), each unit of the analysis node 10 repeats the processing from step B1. When the operation of the analysis system is stopped (yes at step B5), each unit of the analysis node 10 stops operating.

Next, the operation of the analysis system is described more specifically by citing, as an example, a case where the analysis system in the present example embodiment is used as a video analysis system. Hereinafter, description is made by citing, as an example, an operation when a server that is the analysis node 10 and provided with a CPU including six cores performs the two-stage processing of face detection of a person and extraction of a characteristic quantity for video data input from two cameras that are the data acquisition units 20. In the following description, it is assumed that in the analysis workers 111 performing the face detection processing in the pre-stage analysis unit 110, one process is set for each camera and two processes are set in total as an initial setting. It is assumed that in the analysis workers 121 performing processing of extracting a characteristic quantity of a face in the post-stage analysis unit 120, two processes for a camera 1 and three processes for a camera 2 are set, and five processes are set in total as an initial setting. Further, it is assumed that each process can use up to one CPU core.

When video data are input from the data acquisition units 20 provided as the cameras to the server provided as the analysis node 10, the analysis execution unit 100 analyzes the video data, based on the initial setting. When the analysis execution unit 100 is analyzing the input data, based on the initial setting, the content variation observation unit 300 collects content observation data from the pre-stage analysis unit 110, and stores the collected data in the observation data storage unit 400.

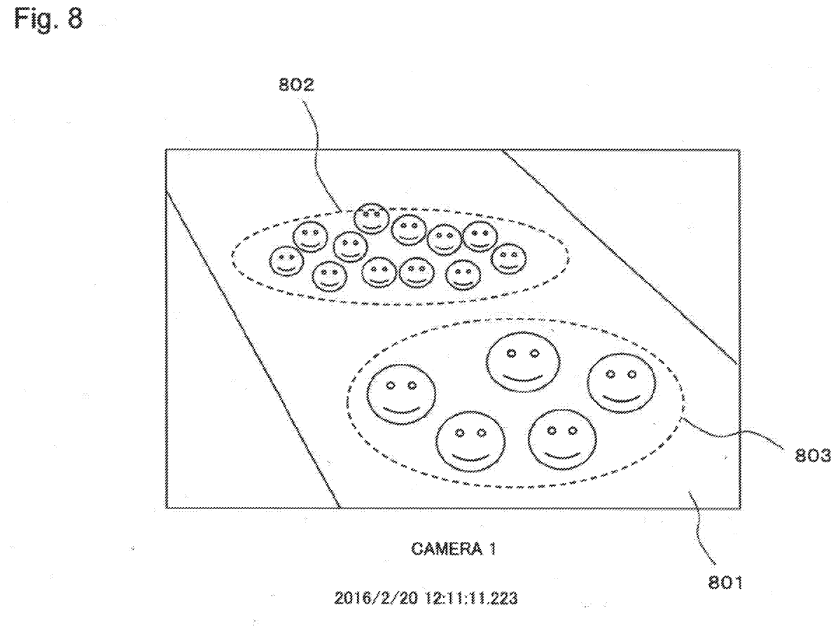

FIG. 8 schematically illustrates an example of a video frame included in video input to the analysis node 10. When processing a video frame as illustrated in FIG. 8, the pre-stage analysis unit 110 detects a face of person passing through a passage 801 in the video frame, for example.

The pre-stage analysis unit 110 determines that among detected faces 802 and faces 803, the faces 803 close to the camera and appearing in a sufficiently large size have quality sufficient as input data for face collation or the like. When the quality is sufficient as input data for face collation or the like, the pre-stage analysis unit 110 sends, to the post-stage analysis unit 120, information of the detected faces 803 as the analysis result to be used for extracting characteristic quantities of faces. Further, the faces 802 distant from the camera and appearing in a small size are determined, by the pre-stage analysis unit 110, as being inappropriate as input data for face collation or the like, and are not sent to the post-stage analysis unit 120. The pre-stage analysis unit 110 holds, as internal information, the number of pieces of data of the faces 802 that are not sent to the post-stage analysis unit 120.

When the pre-stage analysis unit 110 performs the above-described processing on the image in FIG. 8, the content variation observation unit 300 acquires, as the analysis result for the camera 1, five that is the number of the faces 803 appearing in a sufficient size. Further, the content variation observation unit 300 acquires, as internal information for the camera 1, twelve that is the number of the faces 802 distant from the camera 1 and appearing in a small size. When acquiring the numbers of the analysis result and the internal information, the content variation observation unit 300 stores, as internal observation data, the acquired numbers of the analysis result and the internal information in the observation data storage unit 400.

The load observation unit 200 collects load information from the analysis workers 111 and the analysis workers 121 in the analysis execution unit 100. The load observation unit 200 stores the collected load information as load observation data in the observation data storage unit 400.

In the example of FIG. 4, the “worker ID=face detection_1-1” process that is the analysis worker 111 of the pre-stage analysis unit 110 consumes 78% of the CPU cores and consumes 732 MB of the memory. Since the server is constituted of the six core CPU, a consumption quantity of the CPU required to be equal to or smaller than 600%. In FIG. 4, a total usage rate of the CPU cores used by the five processes performed in the analysis workers 111 and the analysis workers 121 is 492%. Accordingly, in the example of FIG. 4, there is a surplus of 108% in a usage rate of the CPU cores.

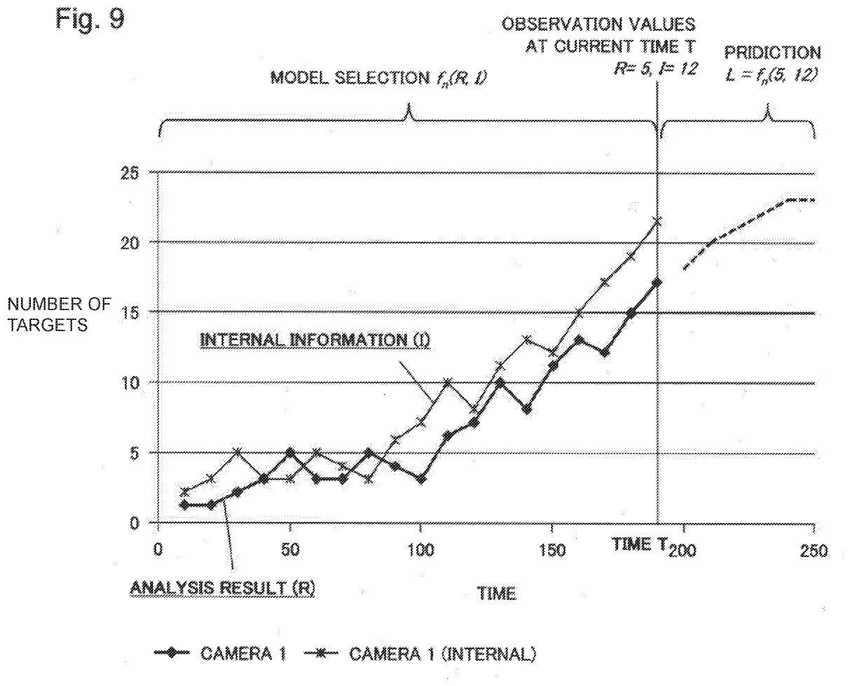

Next, the load variation prediction unit 501 acquires, from the observation data storage unit 400, the content observation data in a period from a time a time length Δt before a current time T until the current time T. The load fluctuation prediction unit 501 predicts content change, based on the acquired content observation data. FIG. 9 illustrates, as a conceptual diagram, an example when prediction is performed with a model base.

In the example of FIG. 9, the load fluctuation prediction unit 501 holds a plurality of model functions f₁(R, I) to f_{N}(R, I) expressing load fluctuation. R is the number of pieces of data of an analysis result in the content observation data. Further, I is the number of pieces of data of the internal information in the content observation data.

Based on the internal observation data in a period from the time a time length Δt before the current time T until the current time T, the load fluctuation prediction unit 501 selects the model fₙ(R, I) that best expresses most recent content variation. When selecting the model fₙ(R, I) that best expresses the most recent content variation, the load fluctuation prediction unit 501 calculates fₙ(5, 12) with the number “R=5” of pieces of data of the analysis result and the number “I=12” of pieces of data of the internal information at the current time T as model arguments. The load variation prediction unit 501 predicts the number of pieces of analysis-target data in the post-stage analysis unit 120 at and after a time “T+1”. Further, in a similar manner, the load fluctuation prediction unit 501 predicts a load in the post-stage analysis unit 120, also for the camera 2.

When predicting a load in the post-stage analysis unit 120, the load fluctuation prediction unit 501 sends the prediction result to the resource allocation planning unit 502.

The load fluctuation prediction unit 501 may predict load fluctuation by another prediction method of a rule base or the like, instead of the method of the model base as described above.

When receiving the prediction result of the load fluctuation from the load fluctuation prediction unit 501, the resource allocation planning unit 502 calculates an optimum value of the number of the analysis workers 121 in the post-stage analysis unit 120, based on the load observation data stored by the observation data storage unit 400, and a load prediction value that is the prediction result of the load fluctuation.

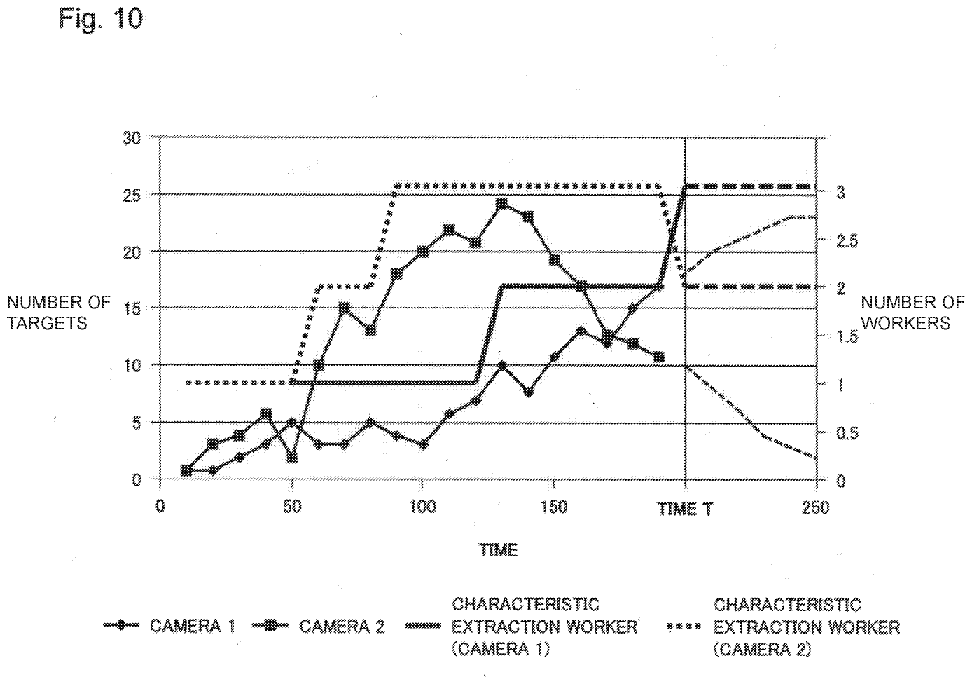

FIG. 10 schematically illustrates an example of the number of pieces of data to be analyzed in the post-stage analysis unit 120, and an actual number and a prediction value of the number of analysis workers 121. In FIG. 10, the load fluctuation prediction unit 501 predicts increase in a load of the camera 1 at and after the time T. However, in the load observation data illustrated in FIG. 4, 179% of the CPU cores is already consumed for processing of extracting face characteristic quantities for the camera 1. Out of a usable quantity 200% of the CPU cores allocated to the two processes, 179% is already consumed, and thus, there is a high possibility that an increasing load cannot be sustained.

Meanwhile, as illustrated in FIG. 10, for camera 2, it is predicted that a load decreases at and after the time T. A consumption quantity of the CPU cores required for processing of extracting face characteristic quantities for the camera 2 is 164%. Accordingly, the consumption quantity of the CPU cores required for processing of extracting face characteristic quantities for the camera 2 has a margin in relation to a usable quantity of 300% of the CPU cores allocated to the three processes. In such a case, in the processing at and after the time T, the resource allocation planning unit 502 increases the number of the analysis workers 121 for the camera 1 by one process, and decreases the number of the analysis workers 121 for the camera 2 by one process.

Thus, monitoring the processing performed in the pre-stage analysis unit 110 and dynamically reviewing a configuration of the analysis workers 121 of the post-stage analysis unit 120 enables the processing in the post-stage analysis unit 120 to be performed efficiently.

### Advantageous Effect of Second Example Embodiment

In the analysis system in the present example embodiment, the resource allocation unit 500 predicts a load of the post-stage analysis unit 120, based on content variation observation data of the pre-stage analysis unit 110. Further, based on the load prediction, the resource allocation unit 500 increases or decreases only the number of analysis workers of the post-stage analysis unit 120. For this reason, the analysis system in the present example embodiment can optimize allocation of computational resources without stopping the operation of the analysis node 10 when changing allocation of computational resources.

Further, in the analysis system in the present example embodiment, the content variation observation unit 300 observes variation in contents of an analysis target. Based on the observation result of the variation in the contents, the resource allocation unit 500 predicts a load of the post-stage analysis unit 120. Thus, the resource allocation unit 500 can change the number of the analysis workers 121 to an optimum number before a load of the post-stage analysis unit 120 actually increases or decreases. Therefore, the analysis system in the present example embodiment can achieve both of a real-time property and high throughput in a system in which load fluctuation frequently occurs. In other words, the analysis system in the present example embodiment can appropriately manage computational resources in relation to load fluctuation, and can continuously perform analysis processing with high throughput.

### Third Example Embodiment

### Configuration of Third Example Embodiment

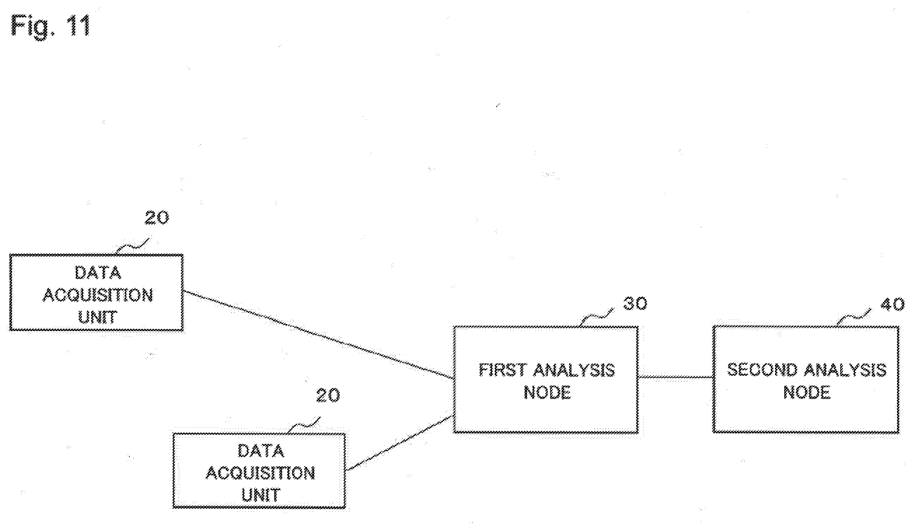

A third example embodiment of the present invention is described in detail with reference to the drawings. FIG. 11 illustrates a configuration of an analysis system in the present example embodiment. The analysis system in the present example embodiment includes a first analysis node 30, a second analysis node 40, and a data acquisition unit 20. The configuration of the data acquisition unit 20 is similar to that of the second example embodiment.

The analysis system in the present example embodiment is characterized in that a part of analysis processing is subjected to distributed processing in the second analysis node 40 when sufficient computational resources cannot be allocated to a post-stage step in the first analysis node 30. Similarly to the second example embodiment, the analysis system in the present example embodiment can be used for a video analysis system or the like for detecting a face of a person from input video data and further extracting a characteristic of the detected face.

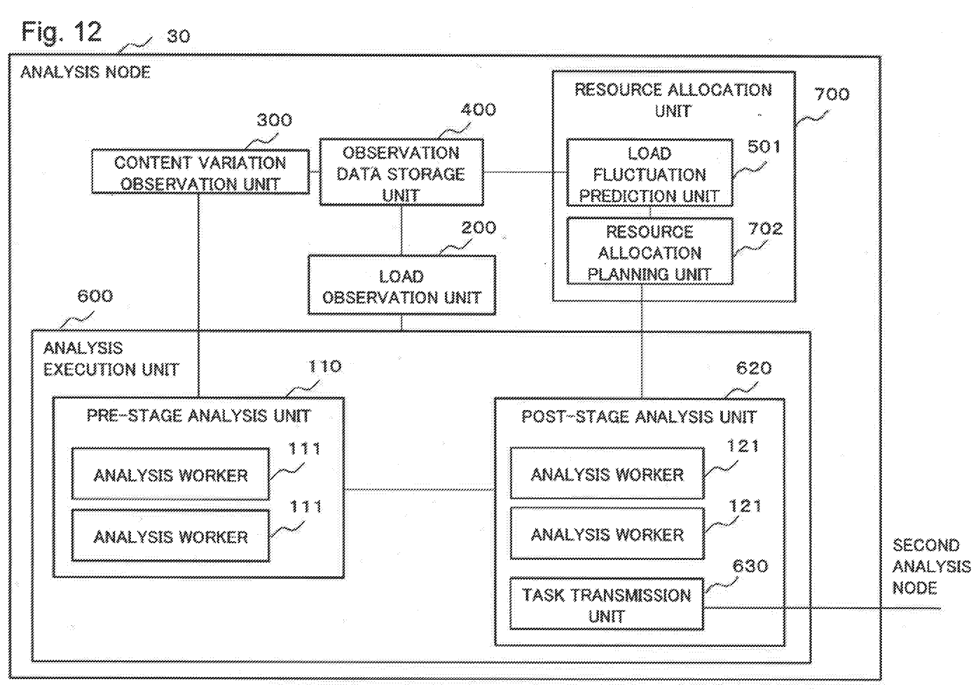

A configuration of the first analysis node 30 is described. FIG. 12 is a block diagram illustrating the configuration of the first analysis node 30 in the present example embodiment. The first analysis node 30 includes an analysis execution unit 600, a load observation unit 200, a content variation observation unit 300, an observation data storage unit 400, and a resource allocation unit 700.

Configurations and functions of the load observation unit 200, the content variation observation unit 300, and the observation data storage unit 400 in the present example embodiment are similar to those of the same-name units in the second example embodiment.

The analysis execution unit 600 analyzes data input from the data acquisition unit 20. The analysis execution unit 600 further includes a pre-stage analysis unit 110 and a post-stage analysis unit 620. The pre-stage analysis unit 110 further includes a plurality of analysis workers 111. Configurations and functions of the pre-stage analysis unit 110 and the analysis workers 111 in the present example embodiment are similar to those of the same-name units in the second example embodiment.

The post-stage analysis unit 620 further includes a plurality of analysis workers 121 and a task transmission unit 630. Configurations and functions of the analysis workers 121 in the present example embodiment are similar to those of the analysis workers 121 in the second example embodiment.

The task transmission unit 630 has a function of transmitting an analysis task to another analysis node, based on control by a resource allocation planning unit 702. Based on a transmission command from the resource allocation planning unit 702, the task transmission unit 630 transmits, to the second analysis node 40, an analysis task determined, by the resource allocation planning unit 702, as a task that cannot be completely processed by the post-stage analysis unit 620 of a self-device.

Similarly to the analysis execution unit 100 of the second example embodiment, the analysis execution unit 600 is constituted of a CPU including a plurality of cores, a semiconductor storage device, a hard disk drive recording a program to be executed by the CPU cores, and the like.

The resource allocation unit 700 includes a load fluctuation prediction unit 501 and the resource allocation planning unit 702. A configuration and a function of the load fluctuation prediction unit 501 in the present example embodiment are similar to those of the load fluctuation prediction unit 501 of the second example embodiment.

The resource allocation planning unit 702 has a similar function as that of the resource allocation planning unit 502 of the second example embodiment. The resource allocation planning unit 702 further has a function of determining whether or not computational resources required for processing of an analysis task are within computational resources allocated to the post-stage analysis unit 620 of the self-device. When determining that computational resources required for processing of an analysis task cannot be secured in the post-stage analysis unit 620 of the self-device, the resource allocation planning unit 702 transmits, to the task transmission unit 630, a command for transmitting a part of the analysis task to the second analysis node 40.

Similarly to the resource allocation unit 500 of the second example embodiment, the resource allocation unit 700 is constituted of a CPU, a semiconductor storage device, a hard disk drive recording a program for performing each processing, and the like.

As the second analysis node 40, an analysis node having the same configuration as that of the first analysis node 30 can be used. Alternatively, the second analysis node 40 may be an analysis node that performs only processing of the post-stage step.

### Operation of Third Example Embodiment

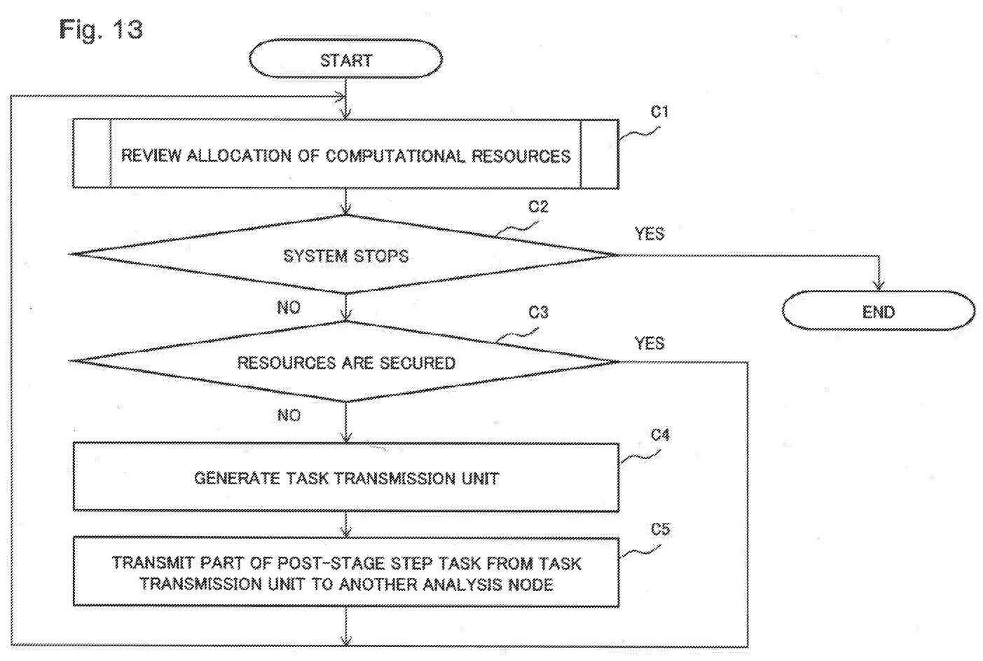

An operation of the analysis system in the present example embodiment is described. FIG. 13 illustrates an operation flow when a part of analysis processing is performed by distributed processing in the analysis system in the present example embodiment.

In the analysis system in the present example embodiment, an operation in which the system is activated in an initial setting, and when analysis processing is performed based on the initial setting, content observation data and load observation data are collected is similar to that of the second example embodiment.

In other words, when the analysis execution unit 600 is performing analysis on input data and performing output of the analysis result, the load observation unit 200 monitors the pre-stage analysis unit 110 and the post-stage analysis unit 620 of the analysis execution unit 600, and collects load observation data of the pre-stage analysis unit 110 and the post-stage analysis unit 620. The load observation unit 200 stores the collected load observation data in the observation data storage unit 400.

The content variation monitoring unit 300 collects, as content observation data, an analysis result and internal information from the pre-stage analysis unit 110. The content variation observation unit 300 stores the collected content observation data in the observation data storage unit 400.

When the load observation data and the content observation data are stored, the load fluctuation prediction unit 501 predicts load fluctuation of the post-stage analysis unit 620, based on the load observation data and the content observation data stored in the observation data storage unit 400. When predicting load fluctuation, the load fluctuation prediction unit 501 sends the prediction result to the resource allocation planning unit 702. When receiving the prediction result of load fluctuation, the resource allocation planning unit 702 reviews allocation of computational resources of the post-stage analysis unit 620 (step C1).

In a case where the operation of the analysis system is stopped (yes at step C2) when allocation of computational resources is reviewed, each unit of the first analysis node 30 stops processing.

In a case where the analysis system continues to operate (no at step C2), when receiving the prediction result of load fluctuation, the resource allocation planning unit 702 determines whether or not computational resources required in the post-stage analysis unit 620 can be secured. When the required resources can be secured (yes at step C3), the resource allocation planning unit 702 changes the number of the analysis workers in the post-stage analysis unit 620 and allocation of resources to the analysis workers, similarly to the second example embodiment.

When a configuration of computational resources is reset by the resource allocation planning unit 702, the analysis execution unit 600 performs analysis on input analysis-target data and performs output of the analysis result, based on the reset configuration. When the analysis execution unit 600 performs the analysis processing, based on the reset configuration, each unit of the first analysis node 30 repeats the operation from the step C1.

When the required resources cannot be secured (no at step C3), the resource allocation planning unit 702 generates a task transmission unit 630 (step C4). When generating the task transmission unit 630, the resource allocation planning unit 702 sends, to the task transmission unit 630, a command for transmitting a part of the analysis task in the post-stage analysis unit 620 to the second analysis node 40.

When receiving the command for transmitting a part of the analysis task to the second analysis node 40, the task transmission unit 630 transmits a designated analysis task in the command to the second analysis node 40 (step C5). The post-stage analysis unit 620 of the first analysis node 30 and the second analysis node 40 each process the analysis tasks allocated thereto, and output the processing results as final results.

When a part of the analysis task is sent from the task transmission unit 630 to the second analysis node 40, and analysis processing is performed, each unit of the first analysis node 30 and the second analysis node 40 repeatedly perform the above-described operation in a period in which the system is operating.

Next, more detailed description is made on an operation when distributed processing of an analysis task is performed in a case where the analysis system in the present example embodiment is applied to a video analysis system.

Hereinafter, description is made on a case where for video of the two cameras, video analysis including two steps of face detection and extraction of a characteristic quantity is processed by a server provided with a CPU including five cores. It is assumed that one process is set for each camera and two processes are set in total as initial deployment in the analysis workers 111 performing face detection processing in the pre-stage analysis unit 110. Further, it is assumed that two processes for the camera 1 and three processes for the camera 2 is set, and five processes are set in total in the analysis workers 621 that perform processing of extracting a characteristic quantity of a face in the post-stage analysis unit 620. In addition, it is assumed that each process can use up to one CPU core.

The resource allocation planning unit 702 calculates an optimum value of the number of the analysis workers 121 in the post-stage analysis unit 620, based on load observation data stored in the observation data storage unit 400 and load prediction data predicted by the load fluctuation prediction unit 501.

In a state like FIG. 4, as illustrated in FIG. 10, the load fluctuation prediction unit 501 predicts increase in a load of the camera 1. However, as illustrated in FIG. 4, in face characteristic-quantity extraction processing for the camera 1, 179% is already consumed in relation to processing capacity of usable quantity 200% of the CPU cores allocated to the two processes. Accordingly, the resource allocation planning unit 702 determines that an increasing load cannot be sustained in a current setting.

Since the first analysis node 30 includes the CPU including five cores, a total consumption quantity of the CPU cores cannot exceed 500%. However, in the example of FIG. 4, a usage rate of the CPU cores used by a total of five processes of the deployed analysis workers 111 and analysis workers 121 is 492%, and a surplus is only 8%. For this reason, computational resources cannot be allocated for the camera 1 by further adding a process of performing face characteristic extraction processing. Thus, the resource allocation planning unit 702 determines that all the processing at the post-stage step cannot be performed in the self-device.

When determining that all the processing cannot be performed in the self-device, the resource allocation planning unit 702 generates the task transmission unit 630, and transmits, from the task transmission unit 630 to the second analysis node 40, an analysis task corresponding to one process of the analysis worker 121 of the post-stage analysis unit 620. Distributed processing is performed by the first analysis node 30 and the second analysis node 40, and thereby the processing can be continued without decreasing a processing speed.

### Advantageous Effect of Third Example Embodiment

In the analysis system in the present example embodiment, the resource allocation planning unit 702 not only increases or decreases the analysis workers 121 of the first analysis node 30, but also generates the task transmission unit 630 for transmitting a task to the second analysis node 40. In the analysis system in the present example embodiment, the task transmission unit 630 distributes, to the second analysis node 40, an analysis task that cannot be processed by the self-device, and thereby throughput of the entire analysis system can be maintained even when a load increases beyond processing capability of the self-device.

In the third example embodiment, the example in which the number of the analysis nodes is two is described, but the analysis system may include three or more analysis nodes. In a case of such a configuration, the analysis node as a transmission source of a task may distribute the task uniformly to the other analysis nodes, or may transmit the task to an analysis node with a small load. A configuration may be made in such a manner that data for analysis are input to each analysis node from a camera or the like, and each analysis node performs analysis processing, and meanwhile transmit a task to each other when processing capability is insufficient. With such a configuration, computational resources can be used more efficiently.

In the third example embodiment, a task is transmitted from the first analysis node 30 to the second analysis node 40 directly, but a configuration may be made in such a manner that a task is distributed uniformly to a plurality of analysis nodes via a message queue.

In the second and third example embodiments, the two steps of the pre-stage step and the post-stage step are performed, but three or more steps of analysis processing may be performed. Even when three or more steps of analysis processing are performed, computational resources to be allocated to a step that is at a post-stage compared with a step of observing content variation are dynamically changed based on the content variation of one of the steps, and thereby, computational resources can be appropriately managed, in relation to load fluctuation, without stopping the operation of the analysis system.

The analysis systems of the second and third example embodiments operate, at a time of activation, based on an initial setting, but may operate, at a time of activation, based on allocation of computational resources to the post-stage step at a time of the previous operation. Such a configuration enables an operation with computational resources being efficiently used from a time of activation.

In the second and third example embodiments, the description is made above with the example of the video analysis system that detects a face of a person, but an analysis target of the video analysis system may be a creature or an object other than a person. Further, the analysis systems of the second and third example embodiments may be used for systems other than a video analysis system, as long as the analysis systems are used for processing data by a plurality of steps of processing.

Processing corresponding to each function of the analysis nodes in the first to third example embodiments may be executed as a computer program by a computer. The program that can cause the computer to perform each processing described in the first to third example embodiments can also be stored in a recording medium and be distributed. Examples used as the recording medium include a data recording magnetic tape or a magnetic disk such as a hard disk. As the recording medium, an optical disk such as a compact disc read only memory (CD-ROM) or a digital versatile disc (DVD), or a magneto optical disk (MO) can be used as well. A semiconductor memory may be used as the recording medium.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2016-226465, filed on Nov. 22, 2016, the disclosure of which is incorporated herein in its entirety by reference.

### REFERENCE SIGNS LIST

1 Analysis execution means
2 Content variation observation means
3 Resource allocation means
10 Analysis node
20 Data acquisition unit
30 First analysis node
40 Second analysis node
100 Analysis execution unit
110 Pre-stage analysis unit
111 Analysis worker
120 Post-stage analysis unit
121 Analysis worker
200 Load observation unit
300 Content variation observation unit
400 Observation data storage unit
500 Resource allocation unit
501 Load fluctuation prediction unit
502 Resource allocation planning unit
600 Analysis execution unit
620 Post-stage analysis unit
630 Task transmission unit
700 Resource allocation unit
702 Resource allocation planning unit
801 Passage
802 Face
803 Face

1. An analysis system, comprising:
a memory that stores a set of instructions; and
at least one processor configured to execute the set of instructions to:
perform analysis processing that includes at least a pre-stage step and a post-stage step, the pre-stage step detecting a face from image data, the post-stage step extracting a characteristic quantity from the face being detected;
observe a first result of the analysis processing in the pre-stage step as internal information, the first result relating to the face being detected which has a size being smaller than a standard size when the face is far from a camera that generates the image data;
observe a second result of the analysis processing in the pre-stage step as an analysis result, the second result relating to the face being detected which has a size being equal to or larger than the standard size when the face is close to the camera; and
change computational resources allocated to the post-stage step based on the analysis result and the internal information.

2. The analysis system according to claim 1, wherein the at least one processor is further configured to execute the set of instructions to determine in the pre-stage step whether the face being detected has the size being equal to or larger than the standard size.

3. The analysis system according to claim 1, wherein the at least one processor is further configured to execute the set of instructions to change the computational resources allocated based on the size of the face observed in the pre-stage step.

4. The analysis system according to claim 1, wherein the at least one processor is further configured to execute the set of instructions to change the computational resources allocated based on a number of the faces observed in the pre-stage step.

5. The analysis system according to claim 1, wherein the at least one processor is further configured to execute the set of instructions to output the analysis result being the second result of the analysis processing in the pre-stage step to the post-stage step, and store the internal information being the first result of the analysis processing in the pre-stage step.

6. The analysis system according to claim 1, wherein the at least one processor is further configured to execute the set of instructions to use a model for predicting fluctuation in a processing load by the computational resources, the model being represented by a number of pieces of data of the analysis result and a number of pieces of data of the internal information.

7. The analysis system according to claim 6, wherein the at least one processor is further configured to execute the set of instructions to select a specified model from a plurality of the models based on content change of the image data observed up to the present time.

8. The analysis system according to claim 1, wherein the at least one processor is further configured to execute the set of instructions to observe, as load observation information, a load when the analysis processing is performed, and change the computational resources allocated to the post-stage step based on the analysis result, the internal information, and the load observation information.

9. The analysis system according to claim 1, wherein the at least one processor is further configured to execute the set of instructions to make a request for performing the analysis processing in the post-stage step to another analysis system when detecting shortage of the computational resources.

10. An analysis method, comprising:
by an information processing device,
performing analysis processing that includes at least a pre-stage step and a post-stage step, the pre-stage step detecting a face from image data, the post-stage step extracting a characteristic quantity from the face being detected;
observing a first result of the analysis processing in the pre-stage step as internal information, the first result relating to the face being detected which has a size being smaller than a standard size when the face is far from a camera that generates the image data;
observing a second result of the analysis processing in the pre-stage step as an analysis result, the second result relating to the face being detected which has a size being equal to or larger than the standard size when the face is close to the camera; and
changing computational resources allocated to the post-stage step based on the analysis result and the internal information.

11. The analysis method according to claim 10, further comprising:
determining in the pre-stage step whether the face being detected has the size being equal to or larger than the standard size.

12. The analysis method according to claim 10, further comprising:
changing the computational resources allocated based on the size of the face observed in the pre-stage step.

13. The analysis method according to claim 10, further comprising:
changing the computational resources allocated based on a number of the faces observed in the pre-stage step.

14. The analysis method according to claim 10, further comprising:
outputting the analysis result being the second result of the analysis processing in the pre-stage step to the post-stage step, and storing the internal information being the first result of the analysis processing in the pre-stage step.

15. A non-transitory computer-readable storage medium in which a program is stored, the program causing a computer to execute:
performing analysis processing that includes at least a pre-stage step and a post-stage step, the pre-stage step detecting a face from image data, the post-stage step extracting a characteristic quantity from the face being detected;
observing a first result of the analysis processing in the pre-stage step as internal information, the first result relating to the face being detected which has a size being smaller than a standard size when the face is far from a camera that generates the image data;
observing a second result of the analysis processing in the pre-stage step as an analysis result, the second result relating to the face being detected which has a size being equal to or larger than the standard size when the face is close to the camera; and
changing computational resources allocated to the post-stage step based on the analysis result and the internal information.

16. The non-transitory computer-readable storage medium according to claim 15, wherein the program causes the computer to execute determining in the pre-stage step whether the face being detected has the size being equal to or larger than the standard size.

17. The non-transitory computer-readable storage medium according to claim 15, wherein the program causes the computer to execute changing the computational resources allocated based on the size of the face observed in the pre-stage step.

18. The non-transitory computer-readable storage medium according to claim 15, wherein the program causes the computer to execute changing the computational resources allocated based on a number of the faces observed in the pre-stage step.

19. The non-transitory computer-readable storage medium according to claim 15, wherein the program causes the computer to execute outputting the analysis result being the second result of the analysis processing in the pre-stage step to the post-stage step, and storing the internal information being the first result of the analysis processing in the pre-stage step.
